(19) United States
(12) Patent Application Publication
(10) Pub. No.: US 2017/0043679 A1
(43) Pub. Date: Feb. 16, 2017

(54) SYSTEM FOR DETECTING DEFORMATION OF CUSHION PAD AND PRODUCTION THEREOF

(71) Applicant: TOYO TIRE & RUBBER CO., LTD., Osaka-shi, Osaka (JP)

(72) Inventors: Takeshi Fukuda, Osaka-shi (JP); Junichi Shigeto, Osaka-shi (JP); Hiroaki Ono, Osaka-shi (JP)

(73) Assignee: TOYO TIRE & RUBBER CO., LTD., Osaka-shi, Osaka (JP)

(21) Appl. No.: 15/304,401

(22) PCT Filed: Apr. 13, 2015
(86) PCT No.: PCT/JP2015/061378

§ 371 Date: Oct. 14, 2016

(30) Foreign Application Priority Data
Apr. 15, 2014 (JP) 2014-083926

(51) Int. Cl. B60N 2/00; G01B 7/24; B60N 2/70

(52) U.S. Cl. CPC B60N 2/002; B60N 2/7017; G01B 7/24

(57) ABSTRACT

The present invention provides a cushion pad with improved durability without feeling of a foreign object. The present invention thus provides a system for detecting a deformation of a cushion pad, comprising; the cushion pad comprising a magnetic elastomer in which magnetic filler is dispersed in an elastomer and an arithmetic average roughness (Ra) is 0.5 to 1.0 μm, and a soft polyurethane foam which is integrated with the magnetic elastomer by adhesion, and a magnetic sensor that detects a magnetic change caused by a deformation of the cushion pad. The present invention also provides a production method thereof.

### TECHNICAL FIELD

The present invention is related to a system for detecting deformation of a cushion pad, in particular a system for detecting whether a person sits on a cushion pad used for a car seat, and a production method thereof.

### BACKGROUND ART

There has been practically used a warning system which detects whether a person sits on a seat in a vehicle, such as an automobile and then alerts if the person does not couple a seat belt. The warning system generally gives off an alert when it detects the sitting of the person and simultaneously detects not coupling the seat belt. The apparatus generally comprises a sitting sensor which detects whether a person is sitting on a seat and a sensor which detects not coupling the seat belt with a buckle although the person is seated, which gives off an alert when the uncoupling of the seat belt is detected. The sitting sensor necessitates high durability because it must detect a person sitting down many times. It is also necessary that, when a person is seated, the person does not feel the sensation of any foreign object in the seat.

JP 2012-108113 A (Patent Literature 1) discloses a sitting sensor equipped in a seat, detecting the sitting of a person, which comprises electrodes facing with each other in a cushion material and detects an electric contact of the electrodes. This sensor employs an electrode and should equip wiring. The wiring can be disconnected by receiving a large displacement and gives some problems in durability. In addition, the electrode is generally made of metallic substance which may create a sensation of a foreign object. Even if the electrode is not metallic, the feeling of a foreign object would easily generate from the other substances.

JP 2011-255743 A (Patent Literature 2) discloses an electrostatic capacitance-type sitting sensor which comprises sensor electrodes facing with each other, between which dielectric substance is inserted, and an electrostatic capacitance-type sensor that measures an electrostatic capacity between the electrodes. This sensor also employs electrodes and should equip wiring, which gives rise to durability problems as same with Patent Literature 1. It is also difficult to prevent a sensation of a foreign object.

JP 2007-212196 A (Patent Literature 3) discloses a load detection device for a vehicle seat, which comprises a magnetism generator equipped with a displaceable flexible element and a magnetic sensor, equipped with a fixing element of a flame, having a magnetic impedance element that detects a magnetic field generated by the magnetism generator. Since the magnetism generator includes a magnet having a specified size in this device, it is quite difficult to dispose the magnetism generator near a surface of a cushion material without any foreign object sensation. In order to avoid the foreign object sensation, it is considered that the magnetism generator is disposed inside the cushion material, but this leads to the deterioration of detection accuracy.

JP 2006-014756 A (Patent Literature 4) discloses a biosignal detection device which comprises a permanent magnet and a magnetic sensor. Since the device also employs the permanent magnet which would give a foreign object sensation, it is difficult to place the device near a surface of the cushion material. The displacement of the device inside the cushion material leads to the deterioration of detection accuracy.

### CITATION LIST

### Patent Literature

PTL 1 JP 2012-108113 A

PTL 1 JP 2011-255743 A

PTL 1 JP 2007-212196 A

PTL 1 JP 2006-014756 A

### SUMMARY OF INVENTION

### Technical Problem

The present invention is to provide a deformation detection system which enhances durability of cushion pad without feeling of foreign object. As the results of the intense study to achieve the above object, the present inventors have found that a magnetic elastomer wherein magnetic filler is dispersed in an elastomer is used and is combined with a polyurethane foam, whereby magnetic substances can be gathered and concentrated near a surface layer of the cushion pad, thus the present invention having being accomplished.

### Solution to Problem

Accordingly, the present invention provides a system for detecting a deformation of a cushion pad, which comprises;

the cushion pad comprising a magnetic elastomer in which magnetic filler is dispersed in an elastomer, and a soft polyurethane foam which is integrated with the magnetic elastomer by self-adhesion, and

a magnetic sensor that detects a magnetic change caused by a deformation of the cushion pad.

The magnetic filler is preferably localized in a high concentration in one side of the elastomer and an opposite side of the localized surface in the elastomer is self-adhered with the soft polyurethane foam.

It is preferred that a localization degree of the magnetic filler is within the range of 1 to 90.

The magnetic elastomer preferably has a concentration of residual OH group of 0.2 to 0.9 meq/g.

The cushion pas is preferably a seat cushion pad and the deformation to be detected is caused by a sitting of a person.

The present invention also provide a method for producing a system for detecting a deformation of a cushion pad, which comprises the steps of:

a step of preparing a magnetic elastomer wherein magnetic filler is dispersed in an elastomer,

a step of placing the magnetic elastomer in a mold for the cushion pad,

a step of pouring a raw material of a soft polyurethane foam into the mold

a step of foaming the soft polyurethane foam raw material to integrate with the magnetic elastomer, thus forming the cushion pad, and

a step of combining the cushion pad with a magnetic sensor that detects a magnetic change caused by a deformation of the cushion pad.

The magnetic elastomer is preferably disposed in the mold such that an opposite surface of the filler-localized surface of the magnetic elastomer faces an inside of the mold.

In addition, the magnetic elastomer in the above production method preferably has a concentration of a residual OH group of 0.2 to 0.9 meq/g.

### Advantageous Effects of Invention

According to the present invention, since the magnetic filler is dispersed in the elastomer, it can hardly provide a foreign object sensation and would give comfortable feeling when sitting therein, in comparison with that using a solid magnet. In addition, as the magnetic sensor detects a magnetic change caused by the magnetic filler contained in the magnetic elastomer, the magnetic sensor can be disposed separately with a certain distance apart from the magnetic elastomer and can be placed without wiring to connect with an electrode, which does not show any problems, such as cutting wire or poor durability. Further, since wiring to connect with an electrode is not necessary, it is not necessary to place any foreign object in the cushion pad and a production thereof would become easily.

Since the magnetic elastomer is integrated with the soft polyurethane foam by self-adhesion, the magnetic elastomer is hardly peeled off from the cushion pad and shows excellent durability. The resulted cushion pad is soft and comfortable when a person sitting therein, because the magnetic elastomer has elasticity.

### BRIEF DESCRIPTION OF DRAWINGS

FIG. 1 is a schematic sectional view which shows an embodiment that the system for detecting the deformation of the cushion pad is applied to a seat for a vehicle.

FIG. 2 is a schematic view which shows the function or action of the magnetic elastomer of the present invention.

FIG. 3 shows a schematic perspective view of the cushion pad of the present invention.

### DESCRIPTION OF EMBODIMENTS

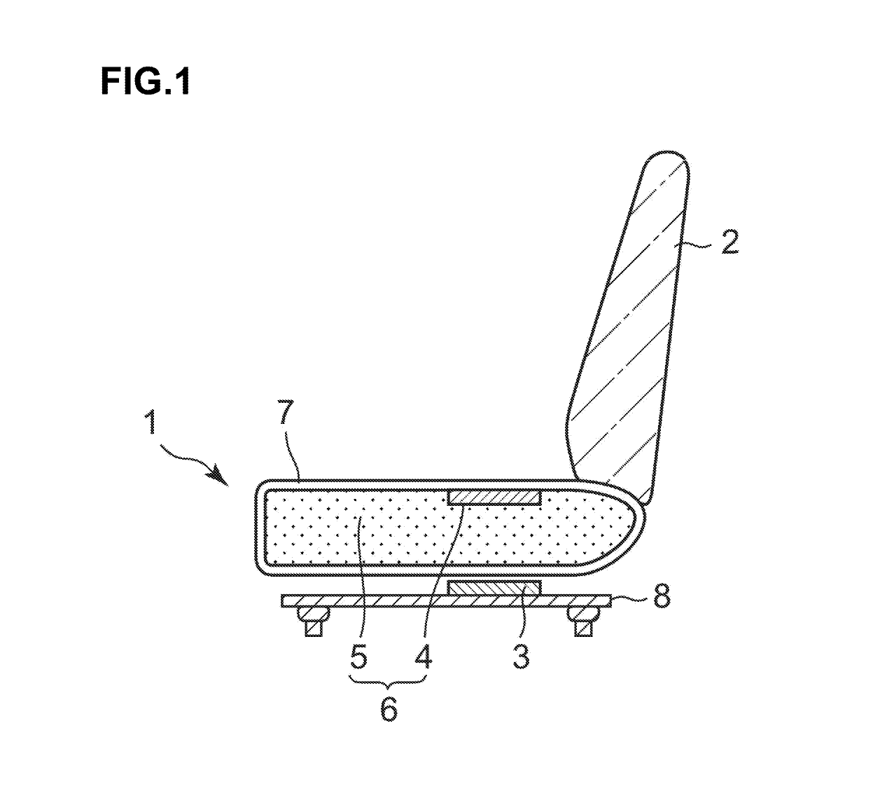

The present invention will be explained in detail by referring FIGS. 1, 2 and 3.

FIG. 1 is a schematic sectional view which shows an embodiment that the system for detecting the deformation of the cushion pad is applied to a seat for a vehicle.

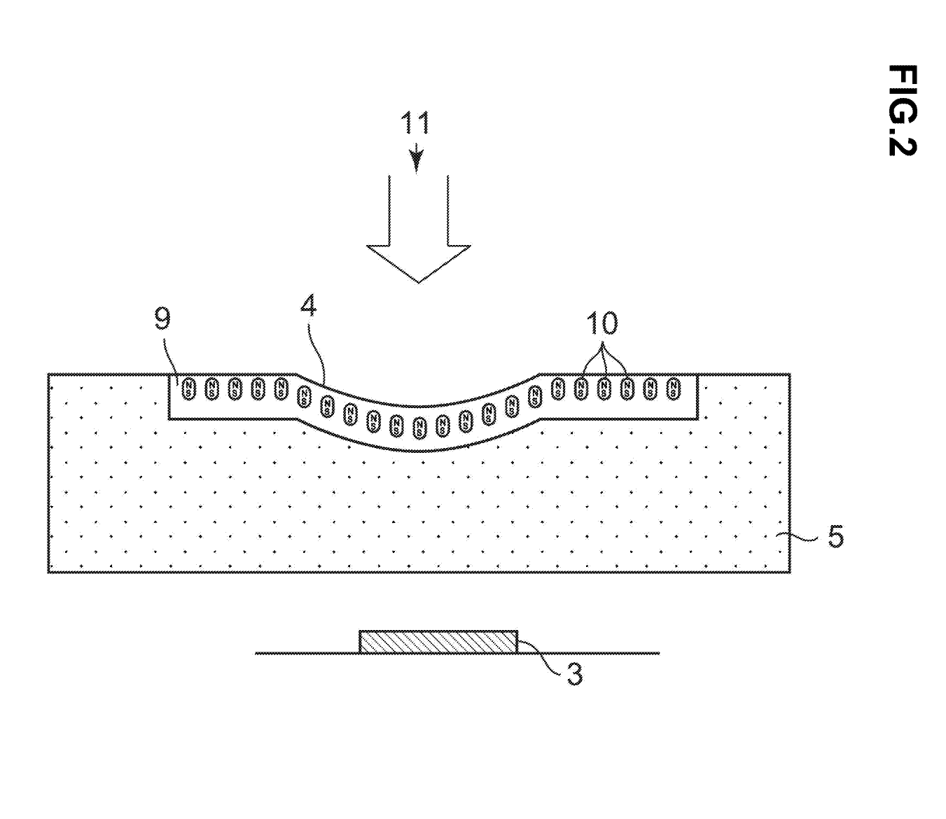

FIG. 2 is a schematic view which shows the function or action of the magnetic elastomer of the present invention.

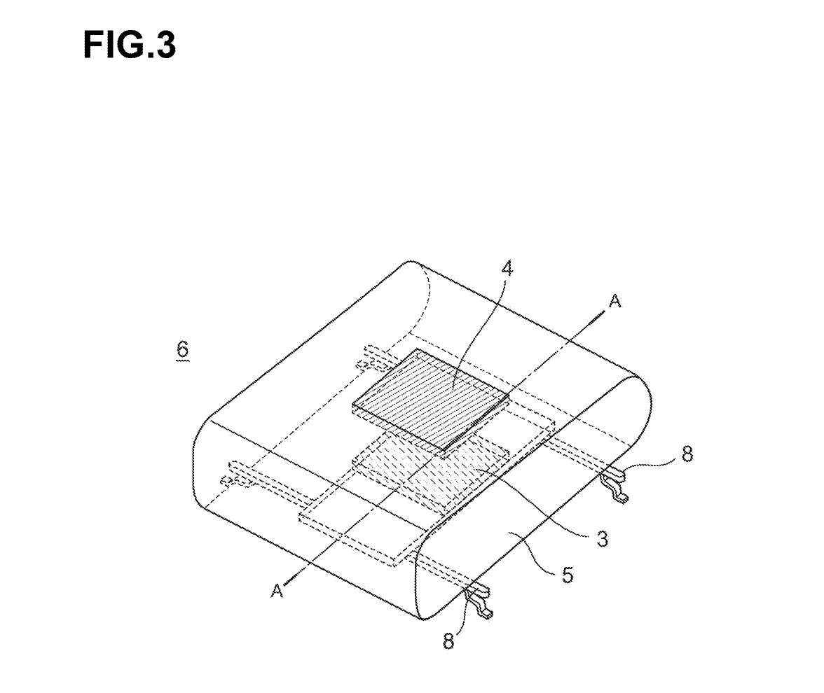

FIG. 3 shows a schematic perspective view of the cushion pad of the present invention.

The system of the present invention is basically composed of a sitting portion 1, a backrest portion 2 and a magnetic sensor 3. The sitting portion 1 is a cushion pad 6 which comprises a magnetic elastomer 4 and a soft polyurethane foam 5, and an outer skin covering the cushion pad 6. The magnetic elastomer is disposed in layer in a portion of the sitting surface of the soft polyurethane foam 5. In the present invention, the magnetic elastomer is self-adhered to the soft polyurethane foam 5 and is hardly peeled off from the soft polyurethane foam 5. It is preferred that the magnetic sensor 3 is fixed to a pedestal 8 supporting the seat for a vehicle. The pedestal 8 is fixed to a car body in the case of a car, which is not shown in the figures.

FIG. 3 shows a perspective view of the cushion pad 6 which comprises the magnetic elastomer 4 and the soft polyurethane foam 5, and it further shows the pedestal 8 and the magnetic sensor 3 mounting on the pedestal 8. FIG. 2 schematically shows an embodiment when the A-A line in FIG. 3 is vertically cut. The magnetic elastomer 4 is disposed on an uppermost portion of the polyurethane foam, which can highly receive the deformation when a person is sitting on the seat. FIG. 3 does not show the outer skin 7 which is present on the magnetic elastomer-containing polymer foam 6. The outer skin 7 is generally made of leather, fabric, synthetic resin or the like, which is not limited thereto.

The magnetic elastomer 4 contains many particles of the magnetic filler 10 in the elastomer 9, as shown in FIG. 2, and in the present invention, the magnetic filler 10 is localized in a high concentration in an upper portion in the drawing and its localization degree of the magnetic filler is preferably within the range of 1 to 90. In this context, the term “magnetic elastomer” means an elastomer (especially polyurethane elastomer or silicone elastomer, as mentioned hereinafter), in which the magnetic filler (i.e. inorganic filler having magnetism) is dispersed.

The term “localization degree” employed herein means a number which shows a degree of localization of the magnetic filler in the magnetic elastomer, which is determined as follow. A produced elastomer is cut by a razor blade to obtain a sample, of which a cross section is observed by a digital microscope with 100 times. The resulting image is divided into 3 equal parts (upper layer, middle layer and lower layer) in the direction of a thickness of the elastomer by using an image analysis software (WinRoof available from Mitani Corporation) and filler particle numbers in the three layers are counted. A particle number ratio of particle number of each layer divided by particle number of middle layer is shown as magnetic filler abundance ratio of each layer. Then, a value of [magnetic filler abundance ratio of upper layer]−[magnetic filler abundance ratio of lower layer] is determined as localization degree. In this context, the term “upper layer” is a portion of the magnetic elastomer, which receives a pressure when a person sitting. The higher the localization degree, the more the magnetic filler is unevenly present.

FIG. 2 only shows the magnetic elastomer 4, the soft polyurethane foam 5 and the magnetic sensor 3, which are picked up for explaining its function. In FIG. 2, a pressure 11 is downwardly applied on the elastomer 9. The elastomer 9 is deformed by the pressure 11 and the magnetic filler 10 present in the portion where the pressure 11 is applied is downwardly lowered. The downward change of the magnetic filler 10 makes a magnetic field changed, which is detected by the magnetic sensor 3.

The higher the pressure 11, the bigger the position change of the magnetic filler 10. The lower the pressure 11, the smaller the position change of the magnetic filler 10. The magnetic change by the position change would also show the strength of the pressure 11 which is also detectable. FIG. 1 shows only one sensor 3, but number of the sensor 3 and its position can be changeable.

As shown in FIG. 2, the magnetic filler 10 is localized with a high concentration in one side of the elastomer 9 and it is preferred that the localized portion is used as the sitting surface. Accordingly, the change of the magnetic filler 10 would become larger and the detection by the magnetic sensor would be easier.

The localization degree of the magnetic filler 10 is determined as mentioned above. The localization degree can be within the range of 1 to 90, preferably 2 to 90, more preferably 3 to 85. When the localization degree is less than 1, the self-adhesion ability with the soft polyurethane foam would be deteriorated. When it is more than 90, the magnetic elastomer layer would be brittle and be difficult in treatment. The localization degree can be less than 1, but it is preferred that when the localization degree of the magnetic filler 10 is high, thus when the filler is localized heavily, the displacement in the elastomer would be bigger and the detection of the magnetic change would be easier.

The magnetic filler generally includes rare earth-based, iron-based, cobalt based, nickel-based or oxide-based filler, which can be used in the present invention. The rare earth-based magnetic filler is preferred because it shows high magnetism, but is not limited thereto. Neodymium-based magnetic filler or samarium-based magnetic filler is more preferred. A shape of the magnetic filler 10 is not limited, but includes spherical, flake, needle, columnar or indefinite shape. The magnetic filler may preferably have an average particle size of 0.02 to 500 μm, preferably 0.1 to 400 μm, more preferably 0.5 to 300 μm. If it has an average particle size of less than 0.02 μm, the magnetic properties of the magnetic filler would become poor and if it has an average particle size of more than 500 μm, the mechanical properties (e.g. brittleness) of the magnetic elastomer would become poor.

The magnetic filler 10 may be introduced into the elastomer after it is magnetized, but it is preferred that the magnetic filler is magnetized after it is introduced into the elastomer, because the polarity of the magnetic filler can be easily controlled as shown in FIG. 2 and the detection of magnetism can be easily carried out.

The elastomer 9 can be general elastomer, but preferred is thermosetting elastomer if properties, such as compression permanent strain and the like, are taken into consideration. The magnetic filler is introduced into the elastomer and mixed, followed by subjecting to localization treatment to generate the localization of the magnetic filler. In general, the magnetic filler is introduced and kept in stand at room temperature or a determined temperature to settle the magnetic filler by its weight and to localize on the bottom surface. Or the localization can be conducted by physical power, such as centrifugal force or magnetic force.

The elastomer 9 can preferably be polyurethane elastomer or silicone elastomer. When it is polyurethane elastomer, an active hydrogen-containing compound is mixed with the magnetic filler and then an isocyanate compound is mixed to form a mixture solution. It is also conducted by mixing the magnetic filler with the isocyanate compound, into which the active hydrogen-containing compound is mixed, to obtain a mixture solution. The mixture is poured into a mold which has been treated with a mold releasing agent and kept for a determined period, if necessary, to settle the magnetic filler for the localization, followed by heating it to a curing temperature to obtain the magnetic elastomer. When it is silicone elastomer, a precursor of the silicone elastomer is mixed with a solvent and the magnetic filler, and put in a mold, and if necessary kept to settle the magnetic filler, followed by heating it to a curing temperature to obtain the magnetic elastomer. When forming the mixture solution, a solvent can be added thereto, if necessary.

In this context, the isocyanate component and the active hydrogen-containing component to be employed for the polyurethane elastomer are listed hereinafter.

The isocyanate component is not limited and can be anyone that has been employed in the field of polyurethane. Examples of the isocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate; an aliphatic diisocyanate, such as ethylene diisocyanate, 2,2,4-trimethylhexamethylene diisocyanate, and 1,6-hexamethylene diisocyanate; an alicyclic diisocyanate, such as 1,4-cyclohexane diisocyanate, 4,4′-dicyclohexylmethane diisocyanate, isophorone diisocyanate, and norbornane diisocyanate. The compounds can be used alone or in combination of two or more compounds thereof. In addition, the isocyanate can be modified by urethane modification, allophanate modification, biuret modification, isocyanulate modification or the like.

The active hydrogen-containing compound can be anyone that has been employed in the field of polyurethane. Examples of the active hydrogen-containing compounds are a polyether polyol, such as polytetramethylene glycol, polypropylene glycol, polyethylene glycol and a copolymer of polypropylene oxide and polyethylene oxide; a polyester polyol, such as polybutylene adipate, polyethylene adipate, and 3-methyl-1,5-pentane adipate; a polyester polycarbonate polyol, such as a reaction product of a polyester glycol (e.g. polycaprolactone polyol and polycaprolactone) and an alkylene carbonate; a polyester polycarbonate polyol obtained by reacting ethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof.

In addition to the above-mentioned high molecular weight polyol component, the active hydrogen-containing component can also include a low molecular weight polyol, such as ethylene glycol, 1,2-propylene glycol, 1,3-propylene glycol, 1,4-butanediol, 1,6-hexanediol, neopentyl glycol, 1,4-cyclohexane dimethanol, 3-methyl-1,5-pentanediol, diethylene glycol, triethylene glycol, 1,4-bis(2-hydroxyethoxy)benzene, trimethylolpropane, glycerin, 1,2,6-hexane triol, pentaerythritol, tetramethylol cyclohexane, methyl glucoside, sorbitol, mannitol, dulcitol, sucrose, 2,2,6,6-tetrakis(hydroxymethyl)cyclohexanol, and triethanolamine; and a low molecular weight polyamine, such as ethylenediamine, tolylenediamine, diphenylmethanediamine, diethylenetriamine and the like. These compounds can be used alone or a combination of two or more compounds thereof. A polyamine, including 4,4′-methylenebis(o-chloroaniline)(MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-dimethyltoluene-2,4-diamine, 3,5-diethyltoluene-2,6-diamine, triethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′,5,5′-tetraethyldiphenylmethane, m-xylylenediamine, N,N′-di-sec-butyl-p-phenylenediamine, m-phenylenediamine, p-xylylenediamine; and the like, may also be added thereto.

An amount of the magnetic filler in the elastomer can preferably be 1 to 450 parts by weight, more preferably 2 to 400 parts by weight, based on 100 parts by weigh of the elastomer. Amounts of less than 1 part by weight make it difficult to detect magnetic changes and those of more than 450 parts by weight make the elastomer brittle and do not obtain the desired properties.

In the present invention, it is preferred that the magnetic elastomer has a concentration of residual OH group of 0.2 to 0.9 meq/g. The presence of the residual OH group provides self-adhesion with the soft polyurethane foam. Accordingly, the presence of the residual OH group is important for the self-adhesion. The concentration of residual OH group may preferably be within the range of 0.2 to 0.85 meq/g. If the concentration is less than 0.2 meq/g, the self-adhesion properties would be deteriorated. If the concentration is more than 0.9 meq/g, thermosetting may not occur and once it is thermoset, performance stability is not good. The concentration of residual OH group is determined by dividing an amount (meq) of residual OH group calculated at the time of formulation design, by a total amount (g) of polyurethane elastomer.

The magnetic sensor 3 can be anyone that has generally been used for detecting magnetism. It may include a magnetoresistive element (e.g. a semiconductor magnetoresistive element, an anisotropic magnetoresistive element (AMR), a gigantic magnetoresistive element (GMR) or a tunnel magnetoresistive element (TMR)), a hall element, an inductor, an MI element, a flux gate sensor and the like. The hall element is preferred because it has high S/N ratio.

The present invention also provides a method for producing a system for detecting a deformation of a cushion pad, comprising the cushion pad and a sensor detecting the deformation of the cushion pad, which comprises the steps of:

a step of preparing a magnetic elastomer wherein magnetic filler is dispersed in an elastomer,

a step of placing the magnetic elastomer in a mold for the cushion pad,

a step of pouring a raw material of a soft polyurethane foam into a mold

a step of foaming the soft polyurethane foam raw material to integrate with the magnetic elastomer, thus forming the cushion pad, and

a step of combining the cushion pad with a magnetic sensor that detects a magnetic change caused by a deformation of the cushion pad.

The magnetic elastomer can be produced by formulating the magnetic filler when forming elastomer and localizing (or unevenly distributing) the magnetic filler by leaving it as it is if necessary or by making the magnetic filler localized by another treatment, followed by reacting in the mold, as mentioned above. The resultant magnetic elastomer is disposed in the mold for the cushion pad, into which a raw solution for the soft polyurethane foam. The raw solution is foamed and the OH groups remaining in the magnetic elastomer are reacted with the polyurethane raw solution or hydrogen-bonding is also generated, thus self-adhering between the soft polyurethane foam and the magnetic elastomer. Accordingly, it is preferred that the magnetic elastomer is disposed in a mold such that an opposite surface of the filler-localized surface faces an inside of the mold.

The raw solution of the soft polyurethane foam comprises a polyisocyanate component and an active hydrogen-containing compound (such as a polyol, water or the like). Examples of the polyisocyanate components and the active hydrogen-containing compounds are listed hereinafter.

The polyisocyanate component can be anyone that has been used in the field of polyurethane. Examples of the polyisocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, m-xylylene diisocyanate and the like. It can also be polynuclear compounds of diphenylmethane diisocyanate (crude MDI). The polyisocyanate compound can further be an aliphatic diisocyanate, such as ethylene diisocyanate, 2,2,4-trimethylhexamethylene diisocyanate and 1,6-hexamethylene diisocyanate; an alicyclic diisocyanate, such as 1,4-cyclohexane diisocyanate, 4,4′-dicyclohexylmethane diisocyanate, isophorone diisocyanate, norbornane diisocyanate; and the like. These can be used alone or in combination with two or more isocyanates thereof. In addition, the isocyanate can be modified by urethane modification, allophanate modification, biuret modification, isocyanulate modification or the like.

The active hydrogen-containing compound can be anyone that has generally been used in the field of polyurethane. Examples of the active hydrogen-containing compounds are a polyether polyol, such as polytetramethylene ether glycol, polypropylene glycol, polyethylene glycol and a copolymer of propylene oxide and ethylene oxide; a polyester polyol, such as polybutylene adipate, polyethylene adipate, and 3-methyl-1,5-pentane adipate; a polyester polycarbonate polyol, such as a reaction product of polyester glycol (e.g. polycaprolactone polyol or polycaprolactone) and alkylene carbonate; a polyester polycarbonate polyol obtained by reacting polyethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof. The concrete examples of the active hydrogen-containing compounds include, for example EP 3028, EP 3033, EP 828, POP 3128, POP 3428 and POP 3628, commercially available from Mitsui Chemical Inc.; and the like.

When producing the soft polyurethane foam, other components, such as crosslinking agent, foam stabilizer, catalyst and the like can be employed and they are not limited thereto.

The crosslinking agent may include triethanolamine, diethanolamine or the like. The foam stabilizer may include SF-2962, SRX-274C, 2969T and the like, available from Dow Corning Toray Co., Ltd. Examples of the catalysts are Dabco 33LV available from Air Products Japan Co., Ltd., Toyocat ET, SPF2, MR available from Tosoh Corporation, and like.

In addition, an additive, such as water, toner, flame retardant or the like can be suitably employed if necessary.

Examples of the flame retardants are CR 530 or CR 505 available from Daihachi Chemical Industry Co., Ltd.

The cushion pad obtained by the above method, is combined with a magnetic sensor to obtain a system for detecting a deformation of cushion pad according to the present invention. The cushion pad includes a layer of the magnetic elastomer and the magnetic elastomer is deformed to generate a change of magnetism. The magnetism change is detected by the magnetic sensor to find the person sitting on the seat. In the case of a system for detecting coupling a seat belt of an automobile, it detects the person sitting on the seat and emits a warning during not coupling the seat belt. Once the seat belt is coupled, the warning is not emitted.

### EXAMPLES

The present invention is further explained based on the following examples which, however, are not construed as limiting the present invention to their details.

### Preparation Example 1

### Synthesis of Prepolymer a Having Terminal Isocyanate End Group

A reaction vessel was charged with 85.2 parts by weight of polyol A (polyoxypropylene glycol obtained by adding propylene oxide to glycerin of an initiator, OH value 56 and functionality 3) and dehydrated at a reduced pressure with stirring for one hour. The reaction vessel was then changed to nitrogen atmosphere. Next, 14.8 parts by weight of toluene diisocyanate (2,4 configuration=100%, NCO %=48.3%; available from Mitsui Chemicals Inc.) was added to the reaction vessel and reacted for 3 hours at a temperature of 80° C. in the reaction vessel to synthesize a prepolymer A having a terminal isocyanate group (NCO %=3.58%).

### Preparation Example 2

### Synthesis of Prepolymer B Having Terminal Isocyanate Group

A reaction vessel was charged with 81.2 parts by weight of polyol C (polyoxypropylene glycol obtained by adding propylene oxide to pentaerythritol of an initiator, OH value of 75 and functionality 3) and dehydrated at a reduced pressure with stirring for an hour. The reaction vessel was then changed to nitrogen atmosphere. Next, 18.8 parts by weight of toluene diisocyanate (2,4 configuration=100% and NCO %=48.3%) was added to the reaction vessel and reacted for 3 hours at a temperature of 80° C. to obtain a prepolymer B having a terminal isocyanate group (NCO %=4.55%).

### Example 1

Next, a mixture solution of 213.0 parts by weight of polyol A and 0.39 parts by weight of lead actylate (BTT-24 available from Toey Chemical Industry Co., Ltd.) was mixed with 631.2 parts by weight of neodymium based filler (MF-15P available from Aichi Steel Corporation, average particle size=133 μm) to form a filler dispersion. The filler dispersion was defoamed in a reduced pressure and mixed with 100.0 parts by weight of the prepolymer A which has been defoamed, and then mixed using a planetary centrifugal mixer (available from Thinky Corporation) and defoamed. The reaction solution was poured dropwise on a PET film, which had been treated with a mold releasing agent and also had a spacer of 1.0 mm, and then was adjusted by a nip roller to a 1.0 mm thickness. It was kept for 30 minutes at ambient temperature as it was, as the localization treatment, to sediment the magnetic filler. It was then kept at 80° C. for 1 hour to cure, thus obtaining a magnetic filler dispersed polyurethane elastomer. The resulting elastomer was then magnetized at 1.3 T using a magnetizing apparatus (available from Denshijiki Industry Co., Ltd.) to obtain a magnetic elastomer.

A localization degree was determined according to the following evaluation of localization degree, using the thus-obtained magnetic elastomer. The results are shown in Table 1. Regarding the localization degree, Table 1 includes localization treatment time.

### Evaluation of Localization Degree

The produced elastomer was cut by a razor blade to obtain a sample, of which a cross section was observed by a digital microscope with 100 times. The resulting image was divided into 3 equal parts (upper layer, middle layer and lower layer) in the direction of a thickness of the elastomer by using an image analysis software (WinRoof available from Mitani Corporation) and particle numbers in the three layers were counted. A particle number ratio of particle number of each layer divided by particle number of middle layer was shows as magnetic filler abundance ratio of each layer. Then, a value of [magnetic filler abundance ratio of upper layer]−[magnetic filler abundance ratio of lower layer] was determined as localization degree. In this context, the term “upper layer” is a portion of the magnetic elastomer, which receives a pressure when a person sitting.

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The magnetic elastomer obtained above was cut to 50 mm square and was placed in a mold for cushion pad such a position that the localization surface faced down and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a magnetic elastomer-integrated cushion pad. The cushion pad was subjected to a determination of property stability (%), as explained hereinafter. The results are shown in Table 1. It was also subjected to a surface property, especially surface unevenness on the magnetic filler side of the cushion pad.

### Measurement of Property Stability

The resultant cushion pad was subjected to durability test of 500,000 times and the property stability was determined by a change rate of sensor performance against its initial value. The sensor performance was determined by a change rate of output voltage of a Hall element at the time of applying a pressure of 10 kPa, using a pressure indenter having 40 mmφ for applying pressures.

### Evaluation of Surface Property

The surface property of the resulting magnetic elastomer was determined by the following criteria:

o: No unevenness (Good treatment)

x: Uneven surface (Poor treatment)

### Examples 2 to 11 and Comparative Example 1

A magnetic elastomer was prepared by using the formulation shown in Table 1 and a cushion pad was also obtained as generally described in Example 1. The resulting cushion pad was subjected to the evaluation of localization degree, property stability and surface property. The results are shown in Table 1. It is noted that, in Comparative Example 1, the soft polyurethane foam was not integrated with the magnetic elastomer and they were separately prepared and adhered thereto by double sided adhesive tape, to obtain a cushion pad which was subjected to the same evaluation. The adhesion using the double sided adhesive tape is in an embodiment of prior art and the present invention is characterized by self-adhesion.

| | | | Examples | | | | | | |
|---|---|---|---|---|---|---|---|---|---|
| | | | 1 | 2 | 3 | 4 | 5 | 6 | 7 |
| Formulation | Prepolymer | Prepolymer A | 100.0 | 100.0 | 100.0 | 100.0 | 100.0 | | 100.0 |
| | | Prepolymer B | | | | | | 100.0 | |
| | Curing | Polyol A | 213.0 | 213.0 | 213.0 | 213.0 | 71.0 | | |
| | agent | Polyol B | | | | | 71.0 | | |
| | | Polyol C | | | | | | 406.3 | |
| | | Polyol D | | | | | | | 213.0 |
| | Magnetic | Neodymium based | 631.2 | | 631.2 | 631.2 | 564.7 | 1181.4 | 631.2 |
| | filler | Samarium based | | 631.2 | | | | | |
| | Solvent | Toluene | | | | | | | |
| | Catalyst | Lead octylate | 0.39 | 0.39 | 0.39 | 0.39 | 0.30 | 0.63 | 0.39 |

| | | | | | | | | |
|---|---|---|---|---|---|---|---|---|
| | NCO index | 0.40 | 0.40 | 0.40 | 0.40 | 0.60 | 0.20 | 0.40 |
| | Residual OH group | 0.41 | 0.41 | 0.41 | 0.41 | 0.24 | 0.83 | 0.41 |
| | concentration (meq/g) | | | | | | | |
| Production | Adhesion process | IM | IM | IM | IM | IM | IM | IM |
| conditions | Localization treatment time (min.) | 30 | 30 | 3 | 60 | 30 | 30 | 0 |
| Results | Localization degree | 60.7 | 57.6 | 4.7 | 83.1 | 64.2 | 54.1 | 1.2 |
| | Property stability (%) | 7.4 | 8.1 | 10.6 | 6.6 | 8.4 | 5.8 | 12.3 |
| | Surface property (Magnetic filler side) | ◯ | ◯ | ◯ | ◯ | ◯ | ◯ | ◯ |

| | | | Examples | | | | Comparative |
|---|---|---|---|---|---|---|---|
| | | | 8 | 9 | 10 | 11 | Example 1 |
| Formulation | Prepolymer | Prepolymer A | 100.0 | 100.0 | 100.0 | | 100.0 |
| | | Prepolymer B | | | | 100.0 | |
| | Curing | Polyol A | | 213.0 | | | 213.0 |
| | agent | Polyol B | | | 106.5 | | |
| | | Polyol C | | | | 541.5 | |
| | | Polyol D | 213.0 | | | | |
| | Magnetic | Neodymium based | 631.2 | 631.2 | 481.8 | 1496.8 | 631.2 |
| | filler | Samarium based | | | | | |
| | Solvent | Toluene | | 200.0 | | | |
| | Catalyst | Lead octylate | 3.91 | 0.39 | 0.26 | 8.02 | 0.39 |

| | | | | | | |
|---|---|---|---|---|---|---|
| | NCO index | 0.40 | 0.40 | 0.80 | 0.15 | 0.40 |
| | Residual OH group | 0.41 | 0.41 | 0.10 | 0.93 | 0.41 |
| | concentration (meq/g) | | | | | |
| Production | Adhesion process | IM | IM | IM | IM | DSAT |
| conditions | Localization treatment time (min.) | 0 | 0 | 30 | 30 | 30 |
| Results | Localization degree | 0.7 | 92.4 | 59.5 | 45.6 | 60.7 |
| | Property stability (%) | 16.8 | 7.6 | 14.3 | 16.4 | 21.6 |
| | Surface property (Magnetic filler side) | ◯ | X | ◯ | ◯ | ◯ |

In Table 1, IM means integrate molding and DSAT means double sided adhesive tape.

In the Table, polyol B is a polyoxypropylene glycol obtained by adding propylene oxide to propylene glycol of an initiator, OH value 56 and functionality 2.

Polyol D is a polyester polyol obtained from 3-methyl-1,5-pentanediol and trimethylol propane with adipic acid, OH value 56 and functionality 3.

Samarium based filler is SmFeN alloy fine powder (average 2.5 μm, available from Sumitomo Metal Mining Co., Ltd.

As is apparent from Table 1, the cushion pads of Examples of the present invention are excellent in property stability. However, in Comparative Example 1 where the double sided adhesive tape (DSAT) was used for adhesion, instead of integral molding (IM), the property stability shows more than 20%.

In Example 8, the localization degree of the magnetic filler is small and the adhesion between the magnetic elastomer and the soft polyurethane foam has a tendency of not sufficient and the property stability is not good, but is usable. In Example 9, contrary to Example 8, the property stability is good, but its surface condition is bad and handling property is also poor, but is usable. In Example 10, since the resulting OH group concentration is low and adhesion effect is also insufficient because of chemical effect, the property stability is not good, but is usable. In Example 11, since the resulting OH group concentration is high and elasticity of the magnetic elastomer is too low, the property stability is poor, but it withstands general use.

### INDUSTRIAL APPLICABILITY

The system for detecting a deformation of cushion pad of the present invention can be applied to a seat for a vehicle and is excellent in durability so that it endures a long period of use. In addition, the resulted cushion pad is soft and comfortable even a person sits a long period of time, because the magnetic elastomer has elasticity.

### REFERENCE SIGNS LIST

1 Sitting portion
2 Backrest portion
3 Magnetic sensor
4 Magnetic elastomer
5 Soft polyurethane foam
6 Cushion pad
7 Outer skin
8 Pedestal
9 Elastomer
10 Magnetic filler
11 Pressure

What is claimed is:

1. A system for detecting a deformation of a cushion pad, comprising;
the cushion pad comprising a magnetic elastomer in which magnetic filler is dispersed in an elastomer and an arithmetic average roughness (Ra) is 0.5 to 1.0 μm, and a soft polyurethane foam which is integrated with the magnetic elastomer by adhesion, and
a magnetic sensor that detects a magnetic change caused by a deformation of the cushion pad.

2. The system for detecting the deformation of the cushion pad according to claim 1, wherein the magnetic elastomer has an arithmetic average roughness (Ra) of 1.0 to 8.0 μm.

3. The system for detecting the deformation of the cushion pad according to claim 2, wherein the magnetic elastomer has an arithmetic average roughness (Ra) of 1.0 to 5.0 μm.

4. The system for detecting the deformation of the cushion pad according to claim 1, wherein the magnetic elastomer has a maximum height roughness (Rz) of 5.0 to 50.0 μm.

5. The system for detecting the deformation of the cushion pad according to claim 4, wherein the magnetic elastomer has a maximum height roughness (Rz) of 10.0 to 50.0 μm.

6. The system for detecting the deformation of the cushion pad according to claim 5, wherein the magnetic elastomer has a maximum height roughness (Rz) of 15.0 to 35.0 μm.

7. The system for detecting the deformation of the cushion pad according to claim 1, wherein the magnetic elastomer is integrated with the soft polyurethane foam by self-adhesion.

8. The system for detecting the deformation of the cushion pad according to claim 1, wherein the magnetic elastomer has a concentration of residual OH group of 0.2 to 0.9 meq/g.

9. The system for detecting the deformation of the cushion pad according to claim 8, wherein the magnetic elastomer has a concentration of residual OH group of 0.2 to 0.85 meq/g.

10. The system for detecting the deformation of the cushion pad according to claim 1, wherein the cushion pad is applied to a seat and the deformation to be detected is caused by a sitting of a person.

11. A system for detecting a deformation of a cushion pad, comprising the cushion pad and a sensor detecting the deformation of the cushion pad, wherein the cushion pad is composed of a magnetic elastomer in which magnetic filler is dispersed in an elastomer and an arithmetic average roughness (Ra) is 0.1 to 10 μm, and a soft polyurethane foam which is integrated with the magnetic elastomer by adhesion, and the sensor is a magnetic sensor that detects a magnetic change caused by a deformation of the magnetic elastomer associated with the cushion pad.

12. A method for producing a system for detecting a deformation of a cushion pad, comprising the cushion pad and a sensor detecting the deformation of the cushion pad, which comprises the steps of:
a step of preparing a magnetic elastomer having an arithmetic average roughness (Ra) of 0.1 to 10 μm,
a step of pouring a raw material of a soft polyurethane foam into a mold for a cushion pad, and foaming to form the cushion pad,
a step of integrate the magnetic elastomer with the soft polyurethane foam raw material by adhesion, and
a step of combining the cushion pad with a magnetic sensor that detects a magnetic change caused by a deformation of the cushion pad.

13. The method according to claim 12, wherein the magnetic elastomer has an arithmetic average roughness (Ra) of 1.0 to 8.0 μm.

14. The method according to claim 13, wherein the magnetic elastomer has an arithmetic average roughness (Ra) of 1.0 to 5.0 μm.

15. The method according to claim 12, wherein the magnetic elastomer has a maximum height roughness (Rz) of 5.0 to 50.0 μm.

16. The method according to claim 15, wherein the magnetic elastomer has a maximum height roughness (Rz) of 10.0 to 50.0 μm.

17. The method according to claim 16, wherein the magnetic elastomer has a maximum height roughness (Rz) of 15.0 to 35.0 μm.

18. The method according to claim 12, wherein the cushion pad is applied to a seat and the deformation to be detected is caused by a person sitting.

19. A method for producing a system for detecting a deformation of a cushion pad, comprising the cushion pad and a sensor detecting the deformation of the cushion pad, which comprises the steps of:
a step of preparing a magnetic elastomer having an arithmetic average roughness (Ra) of 0.1 to 10 μm,
a step of disposing the magnetic elastomer in a mold for a cushion pad,
a step of pouring a raw material of a soft polyurethane foam into the mold
a step of foaming the raw material of the soft polyurethane foam to integrate the soft polyurethane foam with the magnetic elastomer by self-adhesion, thus forming a cushion pad, and
a step of combining the cushion pad with a magnetic sensor that detects a magnetic change caused by a deformation of the cushion pad.

20. The method according to claim 19, wherein the magnetic elastomer has an arithmetic average roughness (Ra) of 1.0 to 8.0 μm.

21. The method according to claim 20, wherein the magnetic elastomer has an arithmetic average roughness (Ra) of 1.0 to 5.0 μm.

22. The method according to claim 19, wherein the magnetic elastomer has a maximum height roughness (Rz) of 5.0 to 50.0 μm.

23. The method according to claim 22, wherein the magnetic elastomer has a maximum height roughness (Rz) of 10.0 to 50.0 μm.

24. The method according to claim 23, wherein the magnetic elastomer has a maximum height roughness (Rz) of 15.0 to 35.0 μm.

25. The method according to claim 19, wherein the magnetic elastomer has a concentration of residual OH group of 0.2 to 0.9 meq/g.

26. The method according to claim 25, wherein the magnetic elastomer has a concentration of residual OH group of 0.2 to 0.85 meq/g.

27. The method according to claim 19, wherein the cushion pad is applied to a seat and the deformation to be detected is caused by a sitting of a person.
